(19) United States
(12) Patent Application Publication
(10) Pub. No.: US 2026/0241716 A1
(43) Pub. Date: Aug. 20, 2026

(54) INKJET RECORDING APPARATUS

(71) Applicant: KYOCERA Document Solutions Inc., Osaka (JP)

(72) Inventor: Haruki SAYAMA, Osaka (JP)

(73) Assignee: KYOCERA Document Solutions Inc., Osaka (JP)

(21) Appl. No.: 19/542,422

(22) Filed: Feb. 17, 2026

(30) Foreign Application Priority Data
Feb. 19, 2025 (JP) 2025-025070

(51) Int. Cl. B41J 11/00; B41J 2/165; B41J 13/08; G01V 8/12

(52) U.S. Cl. CPC B41J 11/0095; B41J 2/16526; B41J 11/0085; B41J 13/08; G01V 8/12

(57) ABSTRACT

An inkjet recording apparatus includes an endless conveying belt, a recording head, a sheet detection portion, and a control portion. The conveying belt has, over its entire circumference along its travel direction, a plurality of detection holes arrayed in a sheet conveying area. The sheet detection portion includes a light emitting portion and a light receiving portion facing each other across the conveying belt such that the light emitted from the light emitting portion passes through the detection holes to be received by the light receiving portion. Based on the light-blocked time for which the optical path between the light emitting portion and the light receiving portion is blocked from light by the conveying belt that moves at a predetermined speed, the control portion judges the presence or absence of the sheet.

### INCORPORATION BY REFERENCE

This application is based on and claims the benefit of priority from Japanese Patent Application No. 2025-025070 filed on February 19, 2025, the contents of which are hereby incorporated by reference.

### BACKGROUND

The present disclosure relates to an inkjet recording apparatus.

Conventional inkjet recording apparatuses include an endless conveying belt, a recording head, a sheet detection portion, and a control portion. The conveying belt conveys a sheet. The recording head is disposed to face the conveying belt and forms an image on the sheet by ejecting ink toward the sheet on the conveying belt. The sheet detection portion detects the sheet S on the conveying belt. The control portion is connected to the sheet detection portion.

The conveying belt has, over its entire circumference along its travel direction, a plurality of detection holes arrayed at equal intervals in a conveying area for the sheet. The sheet detection portion includes a light emitting portion and a light receiving portion facing each other across the conveying belt such that the light emitted from the light emitting portion passes through the detection holes to be received by the light receiving portion. When a sheet is placed on the conveying belt, the detection holes are covered by the sheet. While the conveying belt is moving at a predetermined speed, when the control portion detects light-blocked detection holes passing across the optical path between the light emitting portion and the light receiving portion, it judges that the sheet is present.

Inconveniently, with the conventional inkjet recording apparatuses, if any of the detection holes is blocked as by contamination with foreign matter, the control portion can falsely judge that the sheet is present on the conveying belt.

The present invention has been made in view of the above problems and an object of the present invention is to provide an inkjet recording apparatus that can reduce false detection of the sheet.

### SUMMARY

To achieve the above object, an inkjet recording apparatus according to the present invention includes an endless conveying belt, a recording head, a sheet detection portion, and a control portion. The conveying belt conveys a sheet. The recording head is disposed to face the conveying belt and forms an image on the sheet by ejecting ink toward the sheet on the conveying belt. The sheet detection portion detects the sheet on the conveying belt. The control portion is connected to the sheet detection portion. The conveying belt has, over its entire circumference along its travel direction, a plurality of detection holes arrayed in a conveying area for the sheet. The sheet detection portion includes a light emitting portion and a light receiving portion facing each other across the conveying belt such that the light emitted from the light emitting portion passes through the detection holes to be received by the light receiving portion. Based on the light-blocked time for which the optical path between the light emitting portion and the light receiving portion is blocked from light by the conveying belt that moves at a predetermined speed, the control portion judges the presence or absence of the sheet.

Further objects of the present disclosure and specific advantages achieved according to the present disclosure become more apparent from the following description of the embodiment.

### BRIEF DESCRIPTION OF THE DRAWINGS

FIG. 1 is an outline view of a printer 100 according to one embodiment.

FIG. 2 is a plan view of a recording portion in the printer 100 according to the embodiment.

FIG. 3 is a schematic view of a conveying belt 3 and its surroundings in the printer 100 according to the embodiment.

FIG. 4 is a block diagram of the printer 100 according to the embodiment.

FIG. 5 is a plan view showing part of the conveying belt 3 in the printer 100 according to the embodiment..

FIG. 6 is an outline view around a sheet sensor 62 in the printer 100 according to the embodiment.

FIG. 7 is a diagram showing a signal that a control portion 6 in the printer 100 according to the embodiment receives from the sheet sensor 62.

FIG. 8 is a diagram showing a signal that the control portion 6 in the printer 100 according to the embodiment receives from the sheet sensor 62.

### DETAILED DESCRIPTION

An embodiment of the present disclosure will be described below taking up, as an example, a printer 100 that prints on a sheet S as a recording medium. The type of sheet S is not particularly limited. For example, a sheet of paper is used as the sheet S. In the following descriptions, the direction vertical to the installation surface (for example, a flat floor surface) of the printer 100 is defined as the top-bottom direction.

### Overall construction of the printer

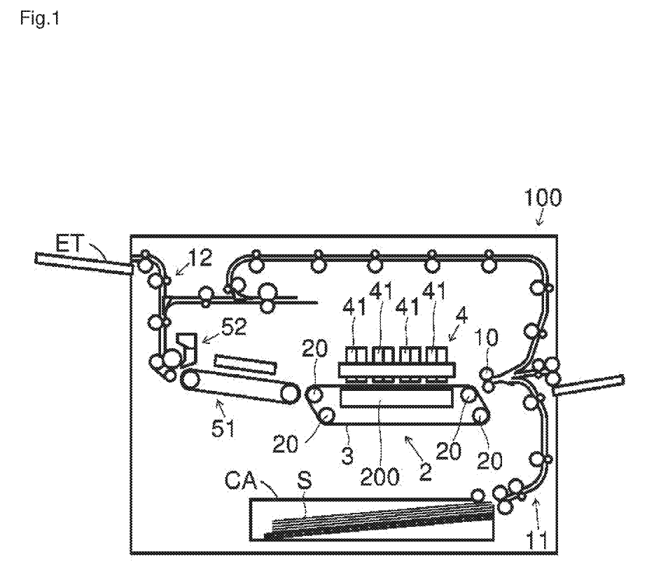

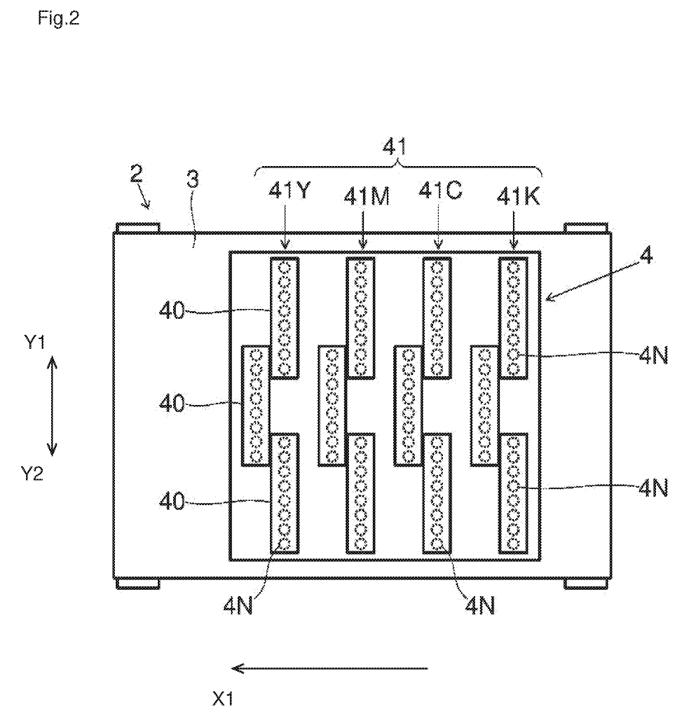

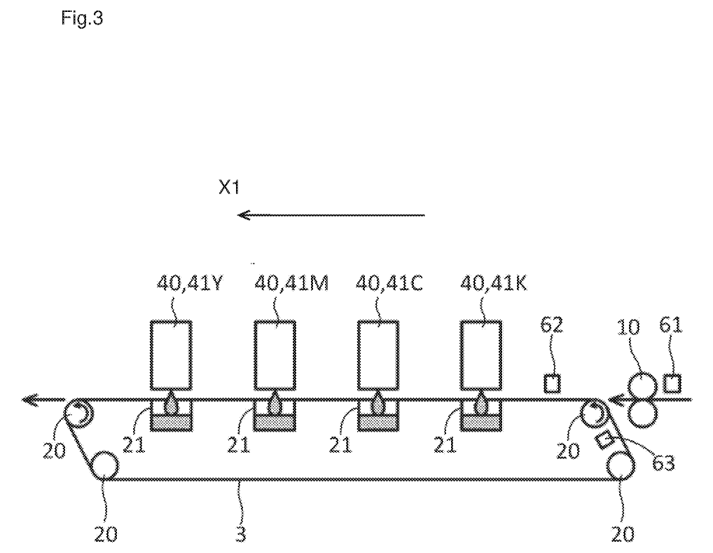

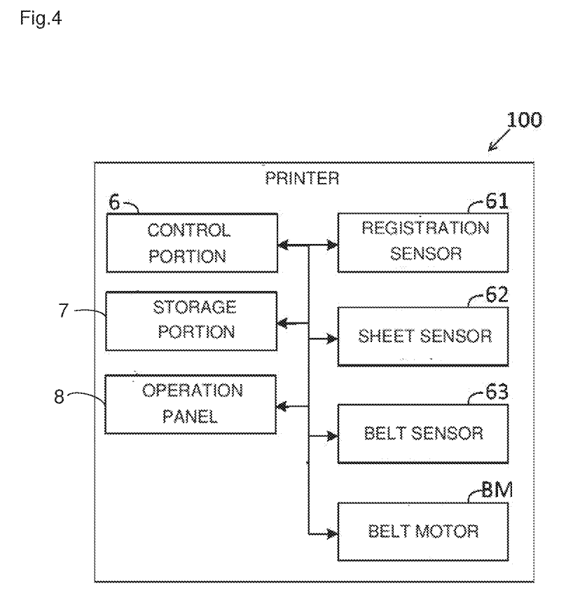

FIG. 1 is an outline view of the printer 100. FIG. 2 is a plan view of a recording portion 4. FIG. 3 is a schematic view of a conveying belt 3 and its surroundings. FIG. 4 is a block diagram of the printer 100.

The printer 100 of the embodiment (corresponding to an “inkjet recording apparatus”) includes a first conveying portion 11 and a second conveying portion 12. The first conveying portion 11 feeds out a sheet S stored in a sheet feed cassette CA and conveys it toward a printing position. In a printing job on the printer 100, ink is ejected onto the sheet S passing through the printing position. This prints an image on the sheet S. The second conveying portion 12 conveys a printed sheet S and discharges it to a discharge tray ET.

The first conveying portion 11 includes a plurality of conveying roller members including a pair of registration rollers 10. In FIG. 1, only the pair of registration rollers 10 among the plurality of conveying roller members is given a reference sign. The plurality of conveying roller members rotate to convey the sheet S. The pair of registration rollers 10 includes a pair of rollers that are in pressed contact with each other. A registration nip is formed between the pair of rollers constituting the pair of registration rollers 10. The sheet S fed out of the sheet feed cassette CA enters the registration nip. The pair of registration rollers 10 rotates to convey the sheet S toward a belt conveying portion 2, which will be described later.

The printer 100 includes the belt conveying portion 2. The belt conveying portion 2 receives the sheet S from the first conveying portion 11 and conveys it. The belt conveying portion 2 includes a plurality of tension rollers 20. The plurality of tension rollers 20 are rotatably supported. The belt conveying portion 2 further includes a conveying belt 3. The conveying belt 3 is endless and is rotatably stretched across the plurality of tension rollers 20. The sheet S is conveyed from the first conveying portion 11 to the belt conveying portion 2 and reaches the outer circumferential surface of the conveying belt 3.

One of the plurality of tension rollers 20 is coupled to a belt motor BM (see FIG. 4), and rotates by being fed with a driving force from the belt motor BM. Rotating the tension roller 20 coupled to the belt motor BM drives the conveying belt 3, and the other tension rollers 20 follow to rotate. In this way, the conveying belt 3 conveys the sheet S. The rotational direction of the conveying belt 3 corresponds to the “movement direction X1”.

The belt conveying portion 2 includes a suction unit 200. The suction unit 200 is disposed at the inner circumferential side of the conveying belt 3. The suction unit 200 sucks the sheet S on the outer circumferential surface of the conveying belt 3 from the inner circumferential side of the conveying belt 3.

Specifically, the conveying belt 3 has a plurality of suction holes (not illustrated) through which the sheet S is sucked. The suction holes in the conveying belt 3 penetrate the conveying belt 3 along its thickness direction. The suction unit 200 sucks the sheet S on the outer circumferential surface of the conveying belt 3 via the suction holes in the conveying belt 3. As a result, the sheet S is adsorbed by suction to the outer circumferential surface of the conveying belt 3. The conveying belt 3 rotates while holding the sheet S by suction on the outer circumferential surface.

The printer 100 includes the recording portion 4. The recording portion 4 is disposed so as to face the outer circumferential surface of the conveying belt 3 along the top-bottom direction. While the sheet S is being conveyed by the conveying belt 3, the sheet S on the outer circumferential surface of the conveying belt 3 and the recording portion 4 face each other across a gap between them along the top-bottom direction. This permits the sheet S, while being conveyed by the conveying belt 3, to pass between a nozzle face of a recording head 40, which will be described later, and the outer circumferential surface of the conveying belt 3. That is, the space between the nozzle face of the recording head 40 and the outer circumferential surface of the conveying belt 3 forms part of the conveying passage for the sheet S. The recording head 40 is disposed above the conveying belt 3, with the nozzle face of the recording head 40 facing downward.

As shown in FIG. 2, the recording portion 4 includes four line heads 41 corresponding to different colors of cyan, magenta, yellow, and black. In FIG. 2, for distinction’s sake, the line head 41 for cyan is given the suffix “C”, the line head 41 for magenta is given the suffix “M”, the line head 41 for yellow is given the suffix “Y”, and the line head 41 for black is given the suffix “K”. This applies also to FIG. 3, which will be referred to later.

The line head 41 for each color includes a plurality of (for example, three) recording heads 40. For example, the plurality of recording heads 40 for each color are arranged in a staggered pattern along the direction orthogonal to the conveying direction of the sheet S X1 by the conveying belt 3. In the following description, the direction orthogonal to the conveying direction of the sheet S X1 by the conveying belt 3 is referred to simply as the width direction (Y1-Y2).

The recording heads 40 are disposed at an interval from the outer circumferential surface of the conveying belt 3 along the top-bottom direction. The conveying belt 3 conveys the sheet S while sucking it below the recording heads 40. The direction orthogonal to both the conveying direction of the sheet S X1 by the conveying belt 3 and the width direction of the sheet S (Y1-Y2) is the top-bottom direction.

The recording head 40 has a nozzle face that faces the outer circumferential surface of the conveying belt 3 along the top-bottom direction. The nozzle face of the recording head 40 has a plurality of nozzles 4N. The plurality of nozzles 4N in the recording head 40 eject ink of the corresponding color downward. For example, the number of nozzles 4N in each recording head 40 is the same. The plurality of nozzles 4N in the recording head 40 is arranged along the width direction of the conveying belt 3. In FIG. 2, the nozzles 4N are indicated by dashed lines. In practice, a larger number of nozzles 4N are provided in each recording head 40.

Based on image data to be printed on the sheet S in the printing job, the recording head 40 ejects ink from the nozzles 4N onto the sheet S on the outer circumferential surface of the conveying belt 3. The ink ejected from the recording head 40 attaches to the sheet S. This forms an image on the sheet S. That is, the area between the recording head 40 and the conveying belt 3 is the printing position and, at this printing position, printing on the sheet S is performed.

As shown in FIG. 3, a waste ink tank 21 is disposed at the inner circumferential side of the conveying belt 3. The waste ink tank 21 stores ink ejected in a flushing process. The ink in the waste ink tank 21 is disposed of.

Returning to FIG. 1, the printer 100 includes a drying unit 51 and a decurler 52. The drying unit 51, while conveying the sheet S toward the decurler 52, dries the ink attached to the sheet S which is being conveyed. The decurler 52 straightens a curl in the sheet S. The decurler 52 conveys the straightened sheet S toward the second conveying portion 12.

As shown in FIG. 4, the printer 100 includes a control portion 6. The control portion 6 includes processing circuits such as a CPU and an ASIC. The control portion 6 controls the printing job. Specifically, the control portion 6 controls the belt motor BM to appropriately move (i.e., rotate) the conveying belt 3. The control portion 6 controls the conveying of the sheet S by the conveying belt 3. The control portion 6 also controls the ejection of ink by the recording head 40. Furthermore, while details will be given later, the control portion 6 controls the flushing process and also controls a meniscus oscillation process.

The control portion 6 is connected to a registration sensor 61, a sheet sensor 62, and a belt sensor 63. The detection positions (arrangement positions) of the registration sensor 61, the sheet sensor 62 and the belt sensor 63 are shown in FIG. 3.

The detection position of the registration sensor 61 is located upstream of the registration nip along the conveying direction of the sheet S. The registration sensor 61 is, for example, a reflective optical sensor or a transmissive optical sensor. The registration sensor 61 changes its output value according to the presence or absence of the sheet S at the corresponding detection position.

Based on the output value of the registration sensor 61, the control portion 6 detects, at the detection position of the registration sensor 61, the arrival of the leading end and the departure of the trailing end of the sheet S. In other words, based on the output value of the registration sensor 61, the control portion 6 detects, at the registration nip, the arrival of the leading end and the departure of the trailing end of the sheet S. Based on the time that elapses after the detection of the arrival of the leading end of the sheet S at the detection position of the registration sensor 61, the control portion 6 determines the time to start conveying the sheet S with the pair of registration rollers 10 (i.e., the time to start rotating the pair of registration rollers 10).

The sheet sensor (sheet detection portion) 62 detects the sheet S on the conveying belt 3. In the embodiment, the detection position of the sheet sensor 62 is located between the printing position of the line head 41 located most upstream along the conveying direction of the sheet S among the plurality of line heads 41 and the registration nip. The sheet sensor 62 changes its output value according to the presence or absence of the sheet S at the corresponding detection position. Based on the output value of the sheet sensor 62, the control portion 6 determines the presence or absence of the sheet S on the conveying belt 3. In the embodiment, used as the sheet sensor 62 is a transmissive optical sensor. The sheet sensor 62 will be described in detail later.

The belt sensor 63 is a sensor for detecting a previously determined reference position (home position) of the conveying belt 3. A predetermined mark is put at the reference position of the conveying belt 3. This permits detection, based on the output value of the belt sensor 63, of the reference position of the conveying belt 3. For example, used as the belt sensor 63 is a CIS. The belt sensor 63 may also be configured with a transmissive optical sensor or a reflective optical sensor.

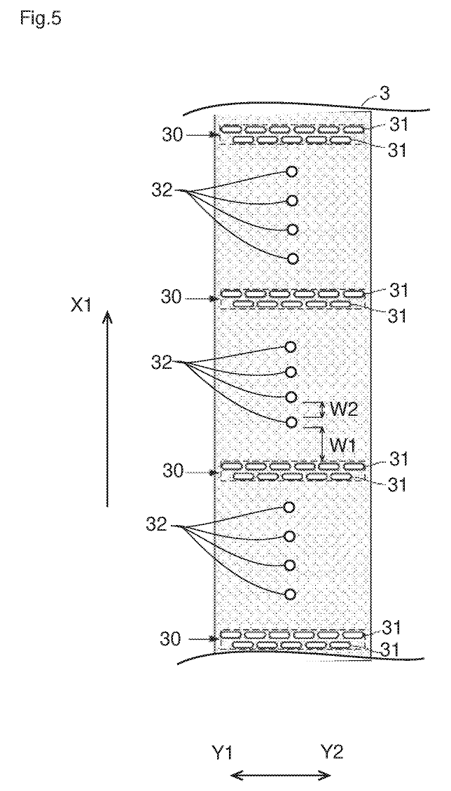

Based on the output value of the belt sensor 63, the control portion 6 detects the reference position of the conveying belt 3. In other words, based on the output value of the belt sensor 63, the control portion 6 detects the position of the flushing region 30 (see FIG. 5) along the rotational direction of the conveying belt 3.

As shown in FIG. 4, the printer 100 includes a storage portion 7. The storage portion 7 includes storage devices such as a ROM, a RAM, a HDD, and an SSD. The storage portion 7 stores various kinds of information and is connected to the control portion 6. The control portion 6 reads information from the storage portion 7 and writes information to the storage portion 7.

The printer 100 includes an operation panel 8. The operation panel 8 is provided with, for example, a touchscreen. The touchscreen displays software buttons, messages and the like and accepts touch operations from the user. The operation panel 8 is also provided with hardware buttons for accepting settings and instructions. The operation panel 8 is connected to the control portion 6. The control portion 6 controls display operation on the operation panel 8 (touchscreen). Furthermore, the control portion 6 detects operations performed on the operation panel 8.

### Construction of the conveying belt

FIG. 5 is a plan view showing part of the conveying belt 3. The conveying belt 3 has flushing holes 31, detection holes 32, and suction holes (not illustrated). A plurality of flushing holes 31 constitute the flushing region 30. In FIG. 5, the flushing region 30 is enclosed by dashed lines. The flushing hole 31, the detection hole 32, and the suction hole each penetrate the conveying belt 3 along its thickness direction.

In the flushing process, ink is ejected from the recording heads 40 and the ejected ink passes through the flushing hole 31 and reaches the inner circumferential side of the conveying belt 3 to be stored in the waste ink tank 21 (see FIG. 3). Performing the flushing process helps suppress clogging.

A plurality of flushing regions 30 are arranged at predetermined intervals along the rotational direction of the conveying belt 3. The conveying belt 3 has the flushing regions 30 and other regions (symbols omitted) alternately along the conveying direction X1.

For example, the flushing hole 31 is an elongated hole that is elongate along the width direction of the conveying belt 3. The shape of the flushing hole 31 (i.e., the shape as seen from the thickness direction of the conveying belt 3) is not particularly limited; it may be rectangular, circular, elliptical, or oval.

In the embodiment, the plurality of flushing holes 31 in each flushing region 30 are arranged in a staggered pattern along the width direction. Specifically, in each flushing region 30, two rows of holes each having a plurality of flushing holes 31 arrayed along the width direction (Y1-Y2) are arrayed along the travel direction X1. The middle position of the row of holes along the width direction (Y1-Y2) is located at the middle position of the conveying belt 3 along the width direction (Y1-Y2). The dimension (opening width) of the flushing hole 31 along the width direction (Y1-Y2) is larger than the interval between two adjacent flushing holes 31 along the width direction (Y1-Y2).

As the conveying belt 3 rotates, each of the plurality of nozzles 4N faces at least one of the flushing holes 31 along the top-bottom direction.

While the conveying belt 3 is being driven, the recording heads 40 perform a flushing process separately from an image formation process. The image formation process is a process of ejecting ink toward the sheet S to form an image on the sheet S.

A plurality of detection holes 32 are arrayed in a sheet conveying area over the entire circumference along the travel direction X1. In the embodiment, four detection holes 32 are disposed between the flushing regions 30 arrayed along the travel direction X1. The detection holes 32 arrayed between the flushing regions 30 are disposed at equal intervals along the travel direction X1. Furthermore, the distance W1 between a flushing hole 31 and a detection hole 32 that are adjacent to each other along the travel direction X1 is larger than the distance W2 between two detection holes 32 that are adjacent to each other along the travel direction X1 between the flushing regions 30. The number of detection holes 32 arrayed between the flushing regions 30 arrayed along the travel direction X1 is not limited to four. Furthermore, the detection holes 32 need not be arrayed at equal intervals along the travel direction X1.

### Configuration of the sheet sensor

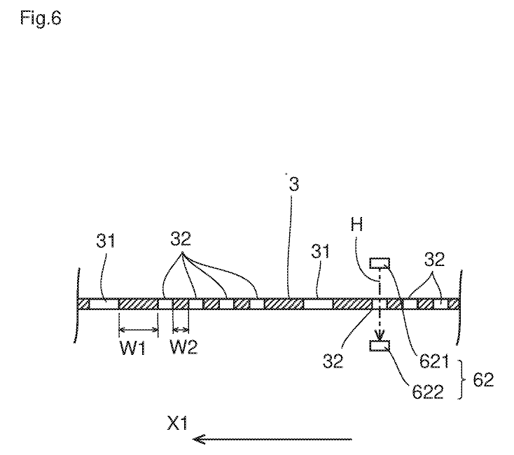

FIG. 6 is an outline view around the sheet sensor 62. In FIG. 6, the optical path H between a light emitting portion 621 and a light receiving portion 622 is indicated by a dashed arrow. The sheet sensor (sheet detection portion) 62 is of a transmissive type that includes the light emitting portion 621 and the light receiving portion 622 facing each other across the conveying belt 3 along the top-bottom direction. The light emitting portion 621 and the light receiving portion 622 are fixed at predetermined positions, and their optical path H coincides with the detection hole 32 along the width direction (Y1-Y2) of the conveying belt 3. The diameter of the detection hole 32 is larger than that of the optical path H.

In this way, when ,while the conveying belt 3 is moving, the detection hole 32 is located to leave the optical path H unblocked, the light emitted from the light emitting portion 621 passes through the detection hole 32 to be received by the light receiving portion 622. On the other hand, when, while the conveying belt 3 is moving, the detection hole 32 is not located to leave the optical path H unblocked, the light emitted from the light emitting portion 621 is blocked by the conveying belt 3. In this case, the light receiving portion 622 does not receive the light from the light emitting portion 621.

In the embodiment, the flushing hole 31 functions also as the detection hole 32. That is, at least one detection hole 32 is configured as the flushing hole 31. As a result, when, while the conveying belt is moving, the flushing hole 31 is located to leave the optical path H unblocked, the light emitted from the light emitting portion 621 passes through the flushing hole 31 to be received by the light receiving portion 622.

As described above, the distance W1 between a flushing hole 31 and a detection hole 32 that are adjacent to each other along the travel direction X1 is larger than the distance W2 between two detection holes 32 that are adjacent to each other along the travel direction X1 between the flushing regions 30. Thus, the detection holes 32 including the flushing holes 31 are arrayed at unequal intervals in at least one section. Accordingly, while the conveying belt is moving at a predetermined speed, the times for which the optical path H between the light emitting portion 621 and the light receiving portion 622 is blocked from light are unequal.

### Control for sheet conveying

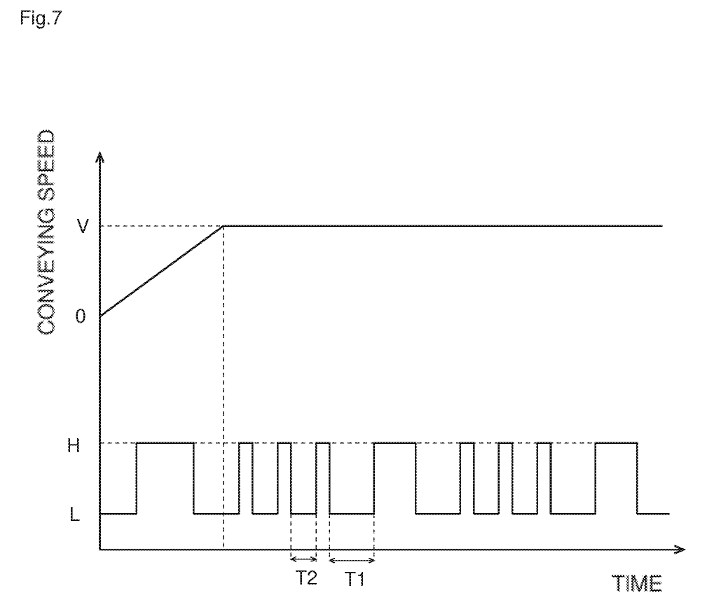

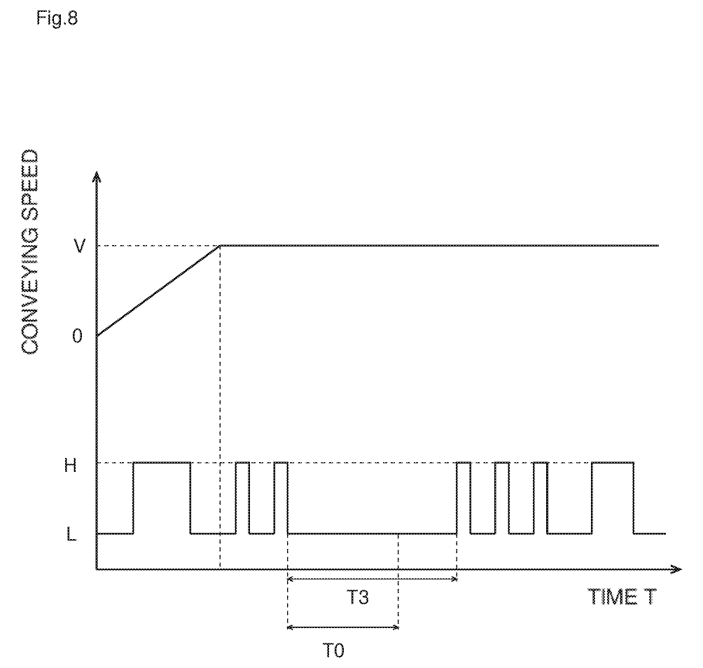

FIGS. 7 and 8 are diagrams showing the signals that the control portion 6 receives from the sheet sensor 62. FIG. 7 shows a case where no sheet S is placed on the conveying belt 3. FIG. 8 shows a case where a sheet S is placed on the conveying belt 3.

To detect the sheet S on the conveying belt 3, the control portion 6 receives a signal output from the light receiving portion 622 of the sheet sensor 62 and stores it in the storage portion 7. Specifically, when the light receiving portion 622 receives the light emitted from the light emitting portion 621, it transmits an H-level signal to the control portion 6. On the other hand, when the light receiving portion 622 does not receive the light emitted from the light emitting portion 621, it transmits an L-level signal to the control portion 6. The control portion 6 counts the reception time (light-blocked time) T in the received L-level signal and stores it in the storage portion 7.

When the belt motor BM starts being driven to move the conveying belt 3, the control portion 6 receives the H-level and L-level signals alternately. Meanwhile, the time T1 for which the conveying belt 3 passes across the optical path H in the section corresponding to the distance W1 between a flushing hole 31 and a detection hole 32 is longer than the time T2 for which the conveying belt 3 passes across the optical path H in the section corresponding to the distance W2 between two adjacent detection holes 32 (see FIG. 7).

When the sheet S is placed on the conveying belt 3, the detection holes 32 including the flushing holes 31 are covered by the sheet S. As a result, while the sheet S is passing across the optical path H, the control portion 6 receives the L-level signal. The time T3 for which the sheet S passes across the optical path H is longer than the times of passing T1 and T2.

After the conveying speed of the conveying belt 3 reaches a predetermined speed, the control portion 6 checks whether the counted reception time (light-blocked time) T is longer than a previously set time and if the counted reception time (light-blocked time) T is longer than the set time T0, the control portion 6 judges that the sheet S is present on the conveying belt 3. On the other hand, if the counted reception time (light-blocked time) T is equal to or shorter than the set time T0, the control portion 6 judges that no sheet S is present on the conveying belt 3.

That is, while the conveying belt is moving at a predetermined speed, based on the light-blocked time T for which the optical path H between the light emitting portion 621 and the light receiving portion 622 is blocked from light, the control portion 6 judges the presence or absence of the sheet S. Since the presence or absence of the sheet S is judged based on the light-blocked time T, even if any of the detection holes 32 is blocked as by contamination with foreign matter, as long as the light-blocked time T does not exceed a predetermined threshold value (set time) T0, it is judged that no sheet S is present. This prevents a false judgement that the sheet S is present on the conveying belt 3. In this way, it is possible to provide a printer (inkjet recording apparatus) 100 that can reduce false detection of the sheet S.

In the embodiment, while the detection holes 32 including the flushing holes 31 are arrayed at unequal intervals in at least one section, if the light-blocked time T counted by the control portion 6 does not exceed the predetermined threshold value (set time) T0, it is judged that no sheet S is present. Thus, a flushing hole 31 and a detection hole 32 can be arrayed apart from each other along the travel direction X1 within the range in which the light-blocked time T does not exceed the set time T0. This helps reduce the passage of ink through the detection holes 32 from outside the flushing region 30 during the flushing process.

Furthermore, making the flushing holes 31 function as the detection holes 32 makes it unnecessary to array the detection holes 32 at equal intervals over the entire circumference of the conveying belt 3. This helps secure the region for forming the flushing holes 31.

The threshold value (set time) T0 is preferably longer than the time for which the section of the conveying belt 3 where adjacent detection holes 32 are located the furthest apart from each other passes across the optical path H. In the embodiment, the threshold value (set time) T0 is set to be longer than the time T1 for which the section between a flushing hole 31 and a detection hole 32 of the conveying belt 3 passes across the optical path H. This prevents the control portion 6 from falsely judging that a sheet S is present on the conveying belt 3 when the section between a flushing hole 31 and a detection hole 32 of the conveying belt 3 passes across the optical path H.

Furthermore, the threshold value (set time) T0 is preferably longer than the time for which the section of the conveying belt 3 where three detection holes 32 are arrayed passes across the optical path H. In the embodiment, the threshold value (set time) T0 is set to be longer than the time for which the section of the conveying belt 3 where the three detection holes 32 are arrayed at equal intervals passes across the optical path H. This prevents, even if the middle detection hole 32 of the three detection holes 32 is blocked as by contamination with foreign matter, the control portion 6 from falsely judging that a sheet S is present on the conveying belt 3. The section where three detection holes 32 are arrayed may be a section where one of the detection holes 32 is a flushing hole 31.

While the threshold value (set time) T0 may be changed according to the size of the sheet S along the travel direction X1, it is preferably shorter than the time for which a sheet S of the largest size along the travel direction X1 of the conveying belt 3 passes across the optical path H. This eliminates the need to change the setting of the threshold value (set time) T0 according to the size of the sheet S, and makes it possible to execute print jobs efficiently.

The embodiment disclosed herein should be understood to be in every aspect illustrative and not meant as any limitation. The scope of the present disclosure is defined not by the above description of the embodiment but by the appended claims, and encompasses any modifications within a scope equivalent in significance to those claims.

For example, the suction hole (not illustrated) may be made to function also as the detection hole 32. That is, at least one detection hole 32 may be configured as the suction hole. In that case, it is preferable to set the diameter of the optical path H smaller than that of the suction hole. Making the suction holes function as the detection holes 32 helps reduce the region for forming the detection holes 32.

Furthermore, the control portion 6 may have a light receiving circuit (not illustrated) and a light blocking circuit (not illustrated). When the light receiving portion 622 receives the light from the light emitting portion 621, the light receiving circuit (not illustrated) processes a light receiving signal transmitted from the sheet sensor (sheet detection portion) 62. When the light from the light emitting portion 622 is blocked, the light blocking circuit (not illustrated) processes a light blocking signal transmitted from the seat sensor (sheet detection portion) 62. In that case, preferably, when the received signal switches from the light receiving signal to the light blocking signal, the light blocking signal is processed based on the light receiving circuit for a predetermined time. As a result, if the light-blocked time T is within the threshold value (set time) T0 at which it is judged that no sheet S is present, processing the light blocking signal based on the light receiving circuit (not illustrated) helps reduce the computation load on the receiving arithmetic processor.

What is claimed is:

1. An inkjet recording apparatus comprising:
an endless conveying belt that conveys a sheet;
a recording head disposed to face the conveying belt, the recording head forming an image on the sheet by ejecting ink toward the sheet on the conveying belt;
a sheet detection portion that detects the sheet on the conveying belt; and
a control portion that is connected to the sheet detection portion,
wherein
the conveying belt has, over an entire circumference thereof along a travel direction thereof, a plurality of detection holes arrayed in a conveying area for the sheet,
the sheet detection portion includes a light emitting portion and a light receiving portion facing each other across the conveying belt such that light emitted from the light emitting portion passes through the detection holes to be received by the light receiving portion,
based on a light-blocked time for which an optical path between the light emitting portion and the light receiving portion is blocked from light by the conveying belt that moves at a predetermined conveying speed, the control portion judges presence or absence of the sheet.

2. The inkjet recording apparatus according to claim 1, wherein
if the light-blocked time is longer than a previously set time, the control portion judges that the sheet is present on the conveying belt,
the detection holes are arrayed at unequal intervals in at least one section,
the set time is longer than a time for which a section of the conveying belt where adjacent detection holes are located the furthest apart from each other passes across the optical path.

3. The inkjet recording apparatus according to claim 1, wherein
if the light-blocked time is longer than a previously set time, the control portion judges that the sheet is present on the conveying belt,
the set time is longer than a time for which a section of the conveying belt where three detection holes are arrayed passes across the optical path.

4. The inkjet recording apparatus according to claim 2, wherein
the set time is shorter than a time for which the sheet of a largest size along the travel direction of the conveying belt passes across the optical path.

5. The inkjet recording apparatus according to claim 1, wherein
the conveying belt has a flushing hole through which flushing liquid ejected from the recording head passes,
at least one detection hole is configured as the flushing hole.

6. The inkjet recording apparatus according to claim 1, wherein
the conveying belt has a suction hole through which the sheet is sucked,
at least one detection hole is configured as the suction hole.

7. The inkjet recording apparatus according to claim 1, wherein
the control portion includes:
a light receiving circuit that processes a light receiving signal transmitted from the sheet detection portion when the light receiving portion receives the light from the light emitting portion; and
a light blocking circuit that processes a light blocking signal transmitted from the sheet detection portion when the light from the light emitting portion is blocked, and
when a received signal switches from the light receiving signal to the light blocking signal, the light blocking signal is processed based on the light receiving circuit for a predetermined time.
